(19) United States
(12) Patent Application Publication
(10) Pub. No.: US 2015/0072269 A1
(43) Pub. Date: Mar. 12, 2015

(54) ELECTRODE ADDITIVE FOR FUEL CELL AND ITS SYNTHESIS METHOD

(71) Applicants: Kia Motors Corporation, Seoul (KR); Hyundai Motor Company, Seoul (KR)

(72) Inventor: Hoon Hui Lee, Seoul (KR)

(73) Assignees: Kia Motors Corporation, Seoul (KR); Hyundai Motor Company, Seoul (KR)

(21) Appl. No.: 14/098,031

(22) Filed: Dec. 5, 2013

(30) Foreign Application Priority Data
Sep. 12, 2013 (KR) 10-2013-0109865

(51) Int. Cl. H01M 4/86; H01M 4/88

(52) U.S. Cl. CPC H01M 4/8663; H01M 4/885; H01M 2004/8684
USPC 429/532; 427/113

(57) ABSTRACT

Disclosed is an electrode additive for a fuel cell and a synthesis method thereof. A synthesis method according to an exemplary embodiment of the present invention includes: producing a metal salt solution by dissolving metal salt in a solvent such as ethylene glycol; producing a carbon-metal salt suspension by distributing carbon in the metal salt solution; heating and cooling the carbon-metal salt suspension and then filtering out the carbon-supported metal powder; cleansing and drying the carbon-supported metal powder; and obtaining carbon-supported metal oxide powder by performing heat treatment on the carbon-supported metal powder at about 300-1000° C. by exposure to water vapor.

### CROSS-REFERENCE TO RELATED APPLICATION

This application claims priority to and the benefit of Korean Patent Application No. 10-2013-0109865 filed in the Korean Intellectual Property Office on Sep. 12, 2013, the entire contents of which are incorporated herein by reference.

### BACKGROUND OF THE INVENTION

(a) Field of the Invention

The present invention relates to an electrode additive for a fuel cell and a synthesis method thereof, and more particularly, to an electrode additive for a fuel cell that can improve synthesis yield of an oxygen evolution catalyst, and a synthesis method thereof.

(b) Description of the Related Art

In general, fuel cells are electrochemical devices that directly convert chemical energy of hydrogen and oxygen into electric energy, particularly by supplying hydrogen and oxygen to an anode and a cathode, respectively, to continuously generate electricity.

In the use of fuel cells, a fuel cell stack is typically formed by stacking several to tens unit cells, each unit cell composed of an MEA (Membrane-Electrode-Assembly), a gas diffusion layer, and a separating plate (bipolar plate). The MEA has a structure in which an anode electrode and a cathode electrode are provided with a macromolecular electrolyte film disposed therebetween.

The principle of generating electricity in a fuel cell is as follows. When fuel (typically hydrogen) is supplied to an anode electrode and is adsorbed by the catalyst on the anode electrode, the fuel is ionized by an oxidation reaction thereby producing electrons. The electrons produced in this process travel to the cathode electrode in accordance with an external circuit, and hydrogen ions travel to the cathode electrode through the macromolecular electrolyte film.

Further, an oxidizer (e.g. air containing oxygen) is supplied to the cathode electrode, and the oxidizer, the hydrogen ions, and the electrons produce water by reacting on the catalyst at the cathode electrode, thereby generating electricity.

The anode electrode is composed of a porous layer containing a carbon support with pores and carbon-based powder as the main components.

When hydrogen is not sufficiently supplied to the anode electrode due to flooding or clogging of a gas channel in operation of a fuel cell, electrons and hydrogen ions are not supplied to the external circuit and the cathode electrode, respectively. This results in an inverse voltage is generated, which means that the voltage of the fuel cell decreases to a minus level.

In this process, carbon which is used in forming the anode electrode oxidizes by reacting with water through a catalytic reaction. This results in an insufficient supply of electrons and protons and generates electrode corrosion, which reduces the performance of the fuel cell.

In order to prevent the carbon oxidation reaction at the anode electrode, a method of adding an OEC (Oxygen Evolution Catalysts) made from metal oxides such as RuO₂ and irO₂ has been used.

When the OECs are added, because the decomposition speed of the water is higher than the oxidation speed of the carbon under the inverse voltage, insufficient electrons and hydrogen ions can be temporarily supplied to the external circuit. This makes it possible to prevent oxidation of the cathode and carbon at the anode electrode, thereby preventing the performance of the fuel cell from decreasing.

However, since the OECs are produced by directly oxidizing precursors containing metal in an oxidizing atmosphere, there are problems in that the catalyst powder becomes rough (about 50˜100 nm) and the OECs must be excessively added to the anode electrode.

Accordingly, in order to reduce the amount of OECs to be added, IrO_{2/}C or RuO_{2/}C have been produced by converting metals such as Ir and Ru into Ir_{/}C or Ru_{/}C by supporting them on a carbon support, using an alcohol reduction method, and then performing oxidation treatment on them in an oxide/air atmosphere.

However, such a method also has a problem in that not only the metal catalysts, but also the carbon that is the material of the support, oxides in the oxidation treatment on Ir_{/}C or Ru_{/}C, as illustrated in FIG. 1. This results in a considerable decrease in the catalyst synthesis yield.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides an electrode additive for a fuel cell having advantages of being able to improve synthesis yield of an oxygen evolution catalyst, and a synthesis method thereof. In particular, the electrode additive is capable of preventing oxidation of carbon, which is the material forming the support, and thus selectively oxidizes only the metal which is used as the oxygen evolution catalyst

According to one aspect, the present invention provides a synthesis method of an electrode additive for a fuel cell including: producing a metal salt solution by dissolving a metal salt in a suitable solvent, such as ethylene glycol; producing a carbon-metal salt suspension by distributing carbon in the metal salt solution; heating and cooling the carbon-metal salt suspension and then filtering out carbon-supported metal powder; cleansing and drying the carbon-supported metal powder; and obtaining a carbon-supported metal oxide powder by performing heat treatment on the carbon-supported metal powder at about 300-1000° C. thereby releasing water vapor.

According to various embodiments, the metal salt is one or more of Ii and Ru.

According to various embodiments, the carbon-supported metal powder contains any one of Ir_{/}C and Ru_{/}C.

According to various embodiments, the carbon-supported metal oxide powder contains any one of IrO_{2/}C and RuO_{2/}C.

According to various embodiments, the carbon-supported metal oxide powder is added in producing an anode electrode.

According to another aspect, the present invention provides an electrode additive for a fuel cell which is formed by using any one of the synthesis methods described herein.

According to an exemplary embodiment of the present invention, an electrode additive is provided which can selectively oxidize only metals without oxidizing carbon. In particular, after metals such as Ir or Ru are supported on a carbon support, when the electrode additive performs oxidation in an oxygen/air atmosphere using an alcohol reduction, great improvements in OEC synthesis yield are achieved. Further, a catalyst with metal oxides, such as IrO₂ or RuO₂, uniformly distributed on the carbon support can be achieved.

Other aspects and exemplary embodiments of the invention are discussed infra.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates pictures of conventionally synthesized carbon-supported metal powder and carbon-supported metal oxide powder.

FIG. 2 is a process flowchart of a method of synthesizing an electrode additive for a fuel cell according to an exemplary embodiment of the present invention.

FIG. 3 illustrates pictures of carbon-supported metal powder and carbon-supported metal oxide powder synthesized by an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

Hereinafter, exemplary embodiments of the present invention will be described in detail with reference to the accompanying drawings.

First of all, the exemplary embodiments described herein and the configurations shown in the drawings are the most preferable exemplary embodiments of the present invention and do not fully cover the spirit of the present invention; therefore, it should be understood that there may be various equivalents and modifications that can replace them at the time of the application. It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

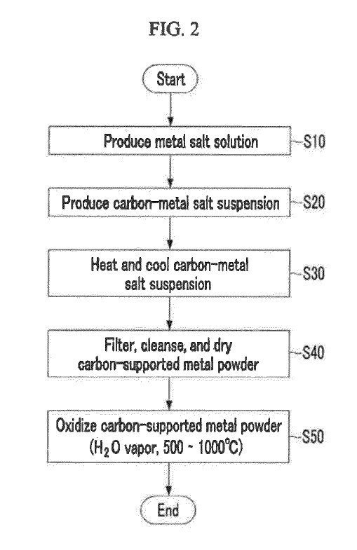

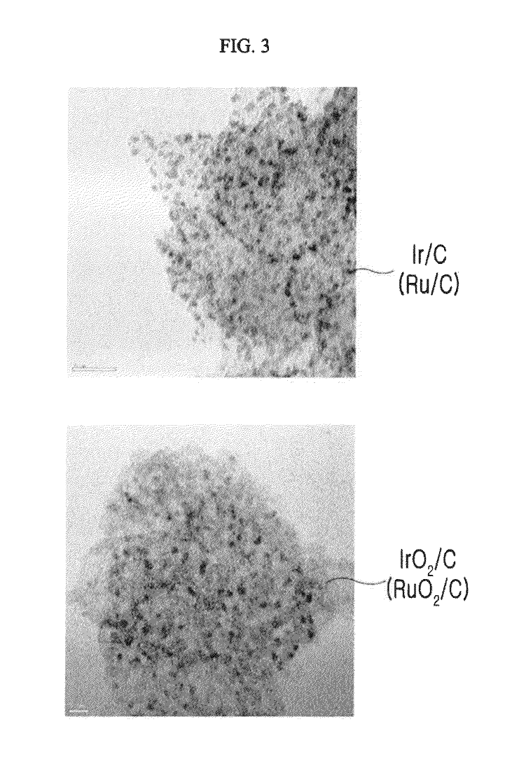

FIG. 2 is a process flowchart of a method of synthesizing an electrode additive for a fuel cell according to an exemplary embodiment of the present invention and FIG. 3 illustrates pictures of carbon-supported metal powder and carbon-supported metal oxide powder synthesized by an exemplary embodiment of the present invention.

The synthesis method of an electrode additive for a fuel cell according to embodiments of the present invention improves the synthesis yield of a catalyst. In particular, the synthesis yield is improved by using water vapor as an oxidizer instead of air and by applying high-temperature heat, in carrying out oxidizing after supporting metals on carbon in an anode electrode. The metals supported on the carbon function as an oxygen evolution catalyst.

As a method of supporting metals on carbon, alcohol reduction can be carried out so as to reduce the metal from a metal salt by reacting alcohol, which functions as a solvent and a reducer, with the metal salt. In particular, alcohol reduction using a divalent or more alcohol (i.e., polyol) having a high boiling point (i.e., a polyol method) may be used.

As illustrated in FIG. 2, the electrode additive for a fuel cell according to an exemplary embodiment of the present invention is produced by producing a metal salt solution (S10), producing a carbon-metal salt suspension (S20), heating and cooling the carbon-metal salt suspension (S30), filtering, cleansing, and drying carbon-supported metal powder (S40), and oxidizing the carbon-supported metal powder (S50).

In particular, a metal salt solution that is used as a stock solution is first produced by adding and dissolving a metal salt while stirring in a divalent or more alcohol (S10). The alcohol is not particularly limited, as long as it is capable of dissolving the metal salt to produce the desired metal salt solution. According to one preferred embodiment, the alcohol used is ethylene glycol.

The metal salt is not particularly limited, and can be any suitable metal salts conventionally used in the field. According to one preferred embodiment, Ir salt or Ru salt is used as an OEC catalyst.

The ethylene glycol is particularly preferred as the reducer is because Ir salt and Ru salt are is easily dissolved in ethylene glycol and are reduced at 180° C. or more. In contrast, it takes a long time to reduce Ir and Ru from Ir salt and Ru salt using solvents such as methanol and ethanol, which have a boiling point lower than that of ethylene glycol.

After the metal salt (e.g., Ir salt and Ru salt) is added to the solvent, the mixture is stirred at about room temperature to dissolve the salt in the solvent (e.g., ethylene glycol). As used in the description of the exemplary embodiment below, the metal salt will be referred to as Ir salt or Ru salt and the solvent as ethylene glycol. However, it is to be understood that other suitable metal salts and solvents can also be used.

In this process, the Ir salt and the Ru salt are dissolved and exist in an ion state in ethylene glycol.

Next, a carbon-metal salt suspension is produced by adding carbon into the metal salt solution, in which the Ir salt or Ru salt are dissolved, and then stirring the mixture so that the added carbon is distributed well within the metal salt solution (S20).

Next, the carbon-metal suspension is heated and cooled (S30) at suitable temperatures as further described below.

As the carbon-metal salt suspension is heated, the Ir ions and/or the Ru ions are reduced and supported on the carbon in the suspension, thereby producing Ir_{/}C or Ru_{/}C.

Then, the temperature is dropped to about room temperature by a cooling fan, cooling chamber, or other suitable cooling means.

After the temperature has been dropped to the desired level, carbon-supported metal powder is filtered from the suspension, cleansed, and dried (S40). Any conventional filtering, cleansing and drying means can be suitably used in view of the material and particle size.

According to various embodiments, the carbon-supported metal powder, that is, Ir_{/}C or Ru_{/}C, is filtered through a filtering film having a filter size smaller than or equal to the size of the powder particles.

Preferably, the filtered carbon-supported metal powder is cleansed several times by distilled water. Drying fans, heaters or any other conventional drying mean can then be used to dry the carbon-supported metal powder.

Thereafter, the carbon-supported metal power undergoes oxidation treatment (S50).

In a typical oxidation treatment process, the carbon-supported metal power is oxidized in an oxygen/air atmosphere. During such oxidation treatment, both the metal and the carbon support material are oxidized. As such, that there is concern that the synthesis yield of the catalyst may be significantly decreased.

On the other hand, in an exemplary embodiment of the present invention, it is possible to set the heating temperature at about 300-1000° C. by using water vapor instead of oxygen as an oxidizer. As such, the carbon-supported metal powder is placed into a chamber and water vapor is sent to the chamber to carry out oxidation.

Since the heating temperature is set by the water vapor, heat treatment is possible at a relatively higher temperature than the conventional method of performing heat treatment in air at 500° C. As such, the OEC synthesis yield can also be improved by the present invention.

It has been found that the OEC synthesis yield may decrease when the heating temperature of oxidation below the lower limit within the range described above (below 300° C.). On the other hand, when the heating temperature exceeds the upper limit (above 1000° C.), carbon may undesirably be oxidized during the process.

Further, in the present process, the water vapor has the effect of producing micro-pores without oxidizing the carbon in the carbon-supported metal powder and also of selectively oxidizing only the metals of Ir and Ru. Thus, according to various embodiments, by carrying out the heat treatment in water vapor, the Ir_{/}C or Ru/C reduces to IrO_{2/}C or RuO_{2/}C by reacting with the water vapor.

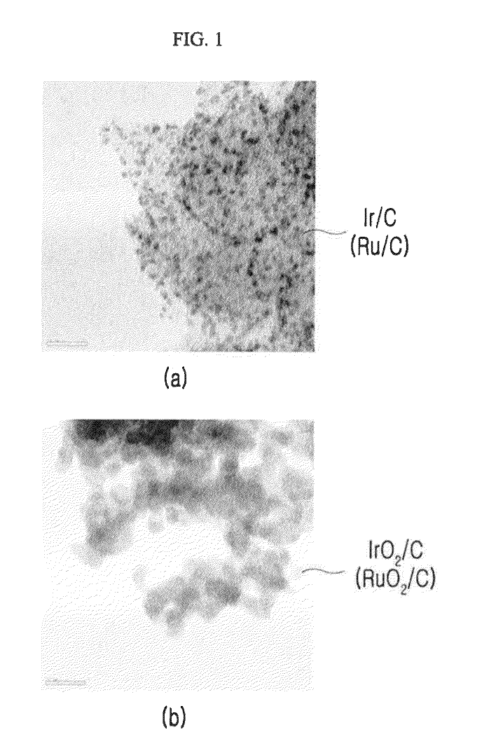

According to the method of the present invention as described above, the OEC synthesis yield is improved, such that a yield of about 90% or more can be achieved, as shown in FIG. 3. This increase in yield is a very progressive result, particularly as compared with that the OEC synthesis yield of 30% or less, when oxidation treatment is performed in an oxygen/air atmosphere, as in the conventional method as shown in FIG. 1.

When the IrO_{2/}C or RuO_{2/}C that is produced by the synthesis method of an electrode additive for a fuel cell according to an exemplary embodiment of the present invention is used to form an anode of a fuel cell, it is capable of preventing carbon corrosion in an anode electrode, even if a reverse voltage is applied to the fuel cell, Still further, it can prevent the reduction of the performance of the fuel cell by rapidly supplying electrons and hydrogen to an external circuit and a cathode.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A synthesis method of an electrode additive for a fuel cell, the method comprising:
producing a metal salt solution by dissolving at least one metal salt in ethylene glycol;
producing a carbon-metal salt suspension by distributing carbon in the metal salt solution;
heating and then subsequently cooling the carbon-metal salt suspension;
filtering, cleansing, and drying carbon-supported metal powder; and
obtaining carbon-supported metal oxide powder by performing heat treatment on the carbon-supported metal powder at about 300-1000° C. by supplying water vapor.

2. The method of claim 1, wherein the metal salt includes any one of Ir and Ru.

3. The method of claim 1, wherein the carbon-supported metal powder includes any one of Ir_{/}C and Ru_{/}C,

4. The method of claim 1, wherein the carbon-supported metal oxide powder includes any one of IrO_{2/}C and RuO_{2/}C.

5. An anode comprising the carbon-supported metal oxide powder of claim 1 disposed on a support.

6. A fuel cell comprising the anode of claim 5. 7, An electrode additive for a fuel cell formed by the method of claim 1.
